(19) United States
(12) Patent Application Publication
(10) Pub. No.: US 2014/0168831 A1
(43) Pub. Date: Jun. 19, 2014

(54) ESD PROTECTION CIRCUIT

(71) Applicant: Kabushiki Kaisha Toshiba, Tokyo (JP)

(72) Inventor: Kentaro WATANABE, Kanagawa (JP)

(73) Assignee: Kabushiki Kaisha Toshiba, Tokyo (JP)

(21) Appl. No.: 13/947,759

(22) Filed: Jul. 22, 2013

(30) Foreign Application Priority Data
Dec. 19, 2012 (JP) 2012-276763

(51) Int. Cl. H02H 9/04

(52) U.S. Cl. CPC H02H 9/04
USPC 361/56

(57) ABSTRACT

According to one embodiment, a protection circuit to protect another circuit from an electrostatic discharge has a transistor having a drain electrode, a source electrode, and a gate electrode, a first terminal connected to the drain electrode, a second terminal connected to the source electrode, an RC circuit including a capacitor and a resistor connected in series, the first RC circuit being connected between the first and the second terminals, a third terminal connected between the capacitor and the resistor and to the gate electrode, and a diode connected between the first and the third terminal. The diode is connected to permit current flow from the third terminal to the first terminal.

### CROSS-REFERENCE TO RELATED APPLICATION

This application is based upon and claims the benefit of priority from Japanese Patent Application No. 2012-276763 filed Dec. 19, 2012, the entire contents of which are incorporated herein by reference.

### FIELD

Embodiments described herein relate generally to an ESD protection circuit.

### BACKGROUND

Recently, various types of protection circuits against Electrostatic Discharge (ESD) have been proposed. ESD means a discharge from an electrostatically charged person or machine to a semiconductor device, a discharge from a charged semiconductor device to earth, and the like. When ESD occurs in a semiconductor device, a large amount of electric charges flow from the terminals of the semiconductor device into the semiconductor device and the electric charges raise the voltage inside the semiconductor device, which causes a dielectric breakdown of the internal elements of the semiconductor device and a fault of the semiconductor device.

As an ESD protection circuit, a protection element known as RC Triggered (RCT) MOS transistor that includes a shunt MOS transistor driven by an RC circuit, is used. When a power supply starts up sharply, the RC circuit responds to it and a shunt MOS transistor is turned on to protect against a surge current although there is no ESD. This hinders the power supply voltage from rising up. In order to prevent this, there is a technique for forcibly turning off the shunt MOS transistor by supplying a control signal to the shunt MOS transistor from an external terminal at the start-up of power supply. With this technique, however, protection against ESD applied to the external terminal that supplies the control signal, should be considered.

### DESCRIPTION OF THE DRAWINGS

FIG. 1 is a circuit diagram showing a protection circuit according to a first embodiment.

FIG. 2 is a circuit diagram showing a protection circuit according to a second embodiment.

FIG. 3 is a circuit diagram showing a protection circuit according to a third embodiment.

FIG. 4 is a circuit diagram showing a protection circuit according to a fourth embodiment.

### DETAILED DESCRIPTION

Embodiments provide an ESD protection circuit capable of preventing a malfunction of a shunt transistor at the start of a power supply and at the same time deal with the ESD applied to a control terminal by applying a control signal for controlling the shunt transistor.

According to an embodiment, a protection circuit to protect another circuit from an electrostatic discharge has a transistor having a drain electrode, a source electrode, and a gate electrode, a first terminal connected to the drain electrode, a second terminal connected to the source electrode, an RC circuit including a capacitor and a resistor connected in series, the first RC circuit being connected between the first and the second terminals, a third terminal connected between the capacitor and the resistor and to the gate electrode, and a diode connected between the first and the third terminal. The diode is connected to permit current flow from the third terminal to the first terminal.

Referring to the attached drawings, hereinafter, an ESD protection circuit according to the embodiments will be described in details. These embodiments are not intended to limit the invention.

### First Embodiment

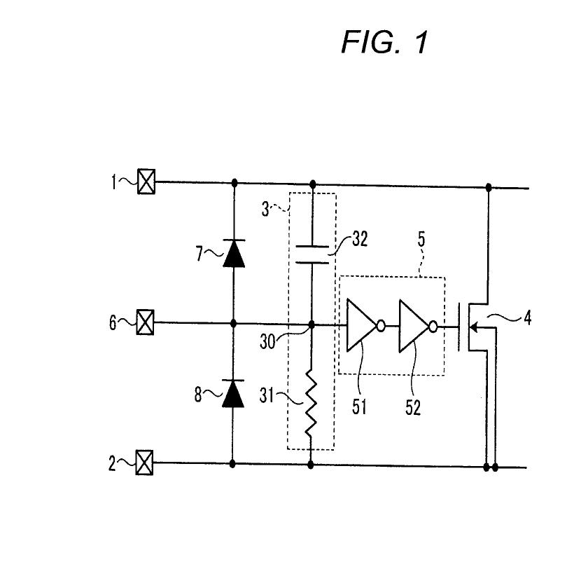

FIG. 1 is a circuit diagram showing an ESD protection circuit according to a first embodiment. A power supply voltage (Vdd) on a high potential level is applied to a first power terminal 1. A power supply voltage (ground potential Vss) on a low potential level is applied to a second power terminal 2. A circuit that the ESD protection circuit protects against ESD, not shown, is connected between the first power terminal 1 and the second power terminal 2. (Hereinafter, the same circuit is connected in the respective embodiments described below.) A first RC circuit 3 including a series circuit of a first resistor 31 and a first capacitor 32 is connected between the first power terminal 1 and the second power terminal 2. A source electrode of a first shunt NMOS transistor 4 is connected to the second power terminal 2 and its drain electrode is connected to the first power terminal 1. Namely, the main current channel, i.e. channel between the source and drain electrodes, of the first shunt NMOS transistor 4 is connected between the first power terminal 1 and the second power terminal 2.

A joint unit of the first resistor 31 and the first capacitor 32 which form the first RC circuit, that is, a first common node 30 is connected to a first control terminal 6. A control signal is supplied to the first control terminal 6 from an external circuit (not shown in FIG. 1). The cathode electrode of a first ESD protection diode 7 is connected to the first power terminal 1 and the anode electrode of the first ESD protection diode 7 is connected to the first control terminal 6. The cathode electrode of a second ESD protection diode 8 is connected to the first control terminal 6 and the anode electrode of the first ESD protection diode 7 is connected to the second power terminal 2. The voltage of the first common node 30 is applied to a first logic circuit 5. The first logic circuit 5 includes two inverters 51, 52 and the output of the inverter 52 is supplied to a control electrode, i.e., a gate electrode, of the first shunt NMOS transistor 4. In this embodiment, the first logic circuit 5 includes the two inverters 51, 52, to shape the waveform of a signal supplied from the first common node 30 to the inverter 51 and to supply the waveform-shaped signal from the inverter 52 to the gate electrode of the first shunt NMOS transistor 4.

When a power supply voltage is not applied on the first power terminal 1 and the second power terminal 2, a control signal is not supplied to the first control terminal 6. In other words, the first control terminal 6 is in a floating state. An example of the state with no power supply voltage being applied to the first power terminal 1 and the second power terminal 2 is the state before a semiconductor device with the ESD protection circuit of the embodiment installed therein is assembled on a predetermined board (not shown).

In this state, when a positive ESD with respect to the potential at the second power terminal 2 is applied to the first power terminal 1, the first RC circuit 3 responds to the ESD and a current depending on the time constant determined by the first resistor 31 and the first capacitor 32 flows in the first resistor 31. When the potential of the first common node 30 attains a High level due to a voltage drop in the first resistor 31, the output level of the first logic circuit 5 attains a High level. When a signal of the High level is supplied to the gate electrode of the first shunt NMOS transistor 4, the first shunt NMOS transistor 4 is turned on. Accordingly, the first NMOS transistor 4 works as an ESD protection element and the surge current based on the positive ESD applied to the first power terminal 1 is discharged from the first power terminal 1 to the second power terminal 2 through the first shunt NMOS transistor 4.

When a positive ESD with respect to the potential at the first power terminal 1 is applied to the first control terminal 6, the ESD protection diode 7 turns on, to discharge the surge current from the first control terminal 6 to the first power terminal 1. When a negative ESD with respect to the potential at the second power terminal 2 is applied to the first control terminal 6, the ESD protection diode 8 turns on, to discharge the surge current from the second power terminal 2 to the first control terminal 6.

In a case where a semiconductor device in which the ESD protection circuit according to the embodiment installed is assembled on a predetermined board (not shown), when a power supply voltage (Vdd) on a high potential level and a power supply voltage (ground potential Vss) on a low potential level are respectively applied to the first power terminal 1 and the second power terminal 2, a ground potential (Vss), which is a fixed potential, is applied to the first control terminal 6. Since the signal of Low level is supplied to the first logic circuit 5, the output of the first logic circuit 5 attains a Low level. As the signal of Low level is supplied to the gate electrode of the first shunt NMOS transistor 4, the first NMOS transistor 4 is turned off. Even when the first RC circuit 3 responds to the start-up of the power supply voltages applied to the first power terminal 1 and the second power terminal 2, the signal supplied to the first logic circuit 5 is at Low level because the control signal having the ground potential is supplied to the first control terminal 6. Therefore, the signal of Low level is supplied to the gate electrode of the first shunt NMOS transistor 4, which keeps the first shunt NMOS transistor 4 in an off-state. Accordingly, it is possible to prevent a malfunction of the first shunt NMOS transistor 4 at the start-up of the power supply voltages. This can avoid the generation of rush current at the start-up of the power supply voltages and the situation in which the power supply voltage fails to reach a predetermined voltage because of the rush current.

### Second Embodiment

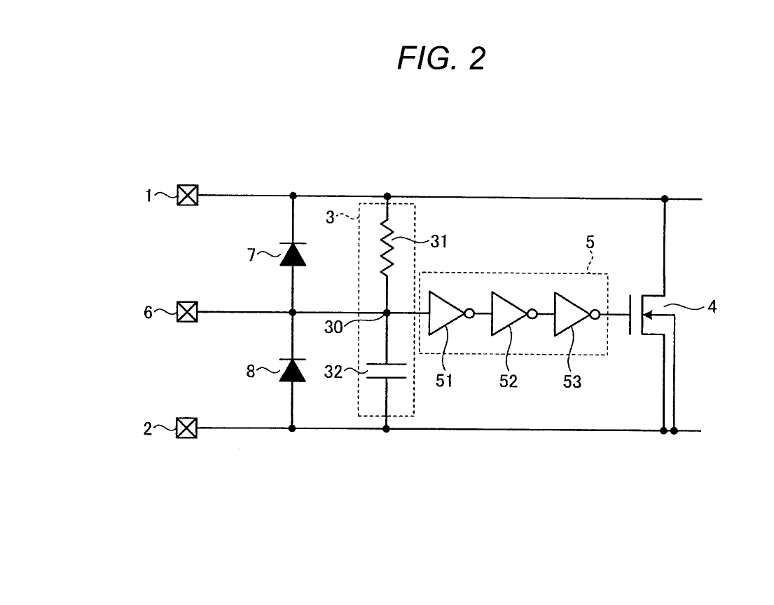

FIG. 2 is a circuit diagram showing an ESD protection circuit according to a second embodiment. The same reference numerals are attached to the components corresponding to the components of the ESD protection circuit according to the first embodiment shown in FIG. 1 and descriptions thereof are omitted. In this embodiment, the first logic circuit 5 includes three inverters 51 to 53. The first RC circuit 3 connected between the first power terminal 1 and the second power terminal 2 includes the first resistor 31 and the first capacitor 32, which are connected in series between the first power terminal 1 and the first control terminal 6. The first resistor 31 is connected to the first capacitor 32 at the first common node 30.

Like the first embodiment, when a power supply voltage is not applied to the first power terminal 1 and the second power terminal 2, a control signal is not supplied to the first control terminal 6. Namely, the first control terminal 6 is in a floating state. When a positive ESD with respect to the potential at the second power terminal 2 is applied to the first power terminal 1, the first RC circuit 3 responds to the ESD and the voltage drops at the first resistor 31.

When the potential of the first common node 30 attains a Low level with respect to the potential of the first power terminal 1, due to this voltage drop, a signal of High level is output from the first logic circuit 5. When the signal of High level is supplied to the gate electrode of the first shunt NMOS transistor 4, the first shunt NMOS transistor 4 is turned on. The first shunt NMOS transistor 4 works as the ESD protection element, to discharge the surge current from the first power terminal 1 to the second power terminal 2. When a positive potential with respect to the potential at the first power terminal 1 is applied to the first control terminal 6 by an ESD, through the ESD protection diode 7, the surge current can flow from the first control terminal 6 to the first power terminal 1. When a negative ESD with respect to the potential at the second power terminal 2 is applied to the first control terminal 6, the ESD protection diode 8 turns on, to discharge the surge current from the second power terminal 2 to the first control terminal 6.

In a case where a semiconductor device in which the ESD protection circuit according to the embodiment installed is assembled on a predetermined board (not shown), when the predetermined power supply voltages, namely, a power supply voltage (Vdd) on a high potential level and a power supply voltage (ground potential Vss) on a low potential level, are applied to the first power terminal 1 and the second power terminal 2, a power supply voltage (Vdd) on a high potential level, which is the fixed potential, is applied to the first control terminal 6. As the signal of High level is supplied to the first logic circuit 5, a signal of Low level is supplied to the gate electrode of the first shunt NMOS transistor 4 through the three inverters 51 to 53 of the first logic circuit 5. As the signal of Low level is supplied to the gate electrode, the first shunt NMOS transistor 4 is turned off. Therefore, even if the first RC circuit 3 responds at the start-up of the power supply voltages when the predetermined power supply voltages are applied to the first power terminal 1 and the second power terminal 2, the first shunt NMOS transistor 4 is forcibly turned off, according to the control signal supplied to the first control terminal 6. This can avoid a malfunction of the first shunt NMOS transistor 4 at the start-up of the power supply voltages. Accordingly, it is possible to avoid the generation of a rush current at the start-up of the power supply and the situation in which the power supply voltage fails to reach a predetermined voltage because of the rush current.

### Third Embodiment

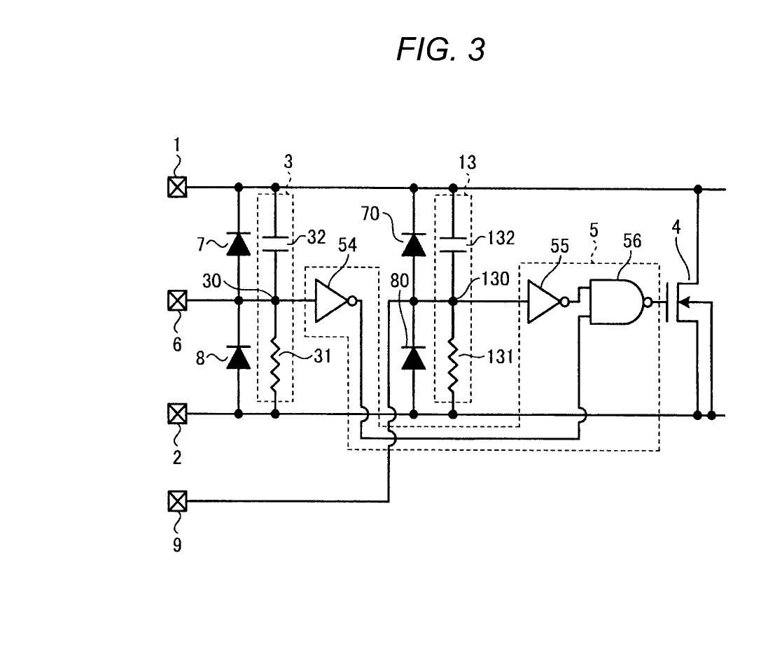

FIG. 3 is a circuit diagram showing an ESD protection circuit according to a third embodiment. The same reference numerals are attached to the components corresponding to the components of the ESD protection circuit according to the first and the second embodiments shown in FIGS. 1 and 2 and descriptions thereof are omitted. This embodiment has a second RC circuit 13 connected between the first power terminal 1 and the second power terminal 2. The second RC circuit 13 includes a second capacitor 132 and a second resistor 131 which are connected in series between the first power terminal 1 and the second power terminal 2. The second capacitor 132 is connected to the second resistor 131 at a second common node 130. The second common node 130 is connected to a second control terminal 9. The first logic circuit 5 includes an inverter 55 with its input terminal being connected to the second common node 130. The first logic circuit 5 further includes a NAND circuit 56. A first input terminal of the NAND circuit 56 is connected to the output terminal of the inverter 55. The output terminal of the NAND circuit 56 is connected to the gate electrode of the first shunt NMOS transistor 4. The first logic circuit 5 further includes an inverter 54 with its input terminal being connected to the first common node 30. The output terminal of the inverter 54 is connected to a second input terminal of the NAND circuit 56. In the embodiment, the first logic circuit 5 supplies the output signal of Low level to the gate electrode of the first shunt NMOS transistor 4 when the potential of the first common node 30 and the second common node 130 is at Low level.

In the embodiment, when the predetermined power supply voltages, namely, a power supply voltage (Vdd) on a high potential level and a power supply voltage (ground potential Vss) on a low potential level, are not applied to the first power terminal 1 and the second power terminal 2, a control signal is not supplied to the first control terminal 6 and the second control terminal 9. Here, the potentials of the first control terminal 6 and the second control terminal 9 are in the floating state. In this mode, when a positive ESD with respect to the second power terminal 2 is applied to the first power terminal 1, the first RC circuit 3 and the second RC circuit 13 respond to the ESD. The potentials of the first common node 30 and the second common node 130 rise due to the voltage drops in the first resistor 31 of the first RC circuit 3 and the second resistor 131 of the second RC circuit 13. When the input levels of the inverter 54 and the inverter 55 attain High, the inverter 54 and the inverter 55 supply the signals of Low level to the NAND circuit 56. Here, the NAND circuit 56 supplies the output signal of High level to the gate electrode of the first shunt NMOS transistor 4. According to this, the first shunt NMOS transistor 4 turns on, to discharge the surge current from the first power terminal 1 to the second power terminal 2.

When a positive ESD with respect to the potential at the first power terminal 1 is applied to the first control terminal 6, the ESD protection diode 7 turns on, to discharge the surge current from the first control terminal 6 to the first power terminal 1. When a negative ESD with respect to the potential at the first power terminal 1 is applied to the first control terminal 6, the second RC circuit 13 responds to the ESD, to drop the voltage in the second resistor 131. Therefore, the potential of the second common node 130 rises and the signal of High level is supplied to the inverter 55. The inverter 55 supplies the signal of Low level to the NAND circuit 56. As the negative ESD with respect to the potential at the first power terminal 1 is applied to the first control terminal 6, the potential of the first common node 30 attains a Low level. A signal of Low level is supplied to the inverter 54 and the output signal of High level is supplied from the inverter 54 to the NAND circuit 56. Thus, as the NAND circuit 56 receives the signal of High level from the inverter 54 and the signal of Low level from the inverter 55, the output attains High level. When a signal of High level is supplied to the gate electrode of the first shunt NMOS transistor 4, the first shunt NMOS transistor 4 is turned on and further through the ESD protection diode 8, the surge current can flow from the first power terminal 1 to the first control terminal 6. When a positive ESD with respect to the potential at the first power terminal 1 is applied to the second power terminal 2, the ESD protection diodes 7 and 8 turn on, to discharge the surge current from the second power terminal 2 to the first power terminal 1.

When a negative ESD with respect to the potential at the second power terminal 2 is applied to the first control terminal 6, the ESD protection diode 8 turns on, to discharge the surge current from the second power terminal 2 to the first control terminal 6. When a positive ESD with respect to the potential at the second power terminal 2 is applied to the first control terminal 6, the potential of the first common node 30 attains a High and the signal of Low level is supplied from the inverter 54 to an input terminal of the NAND circuit 56. Therefore, a signal of High level is supplied from the NAND circuit 56 to the gate electrode of the first shunt NMOS transistor 4. Accordingly, the first NMOS transistor 4 turns on and further the ESD protection diode 7 turns on, to discharge the surge current from the first control terminal 6 to the second power terminal 2.

When a positive ESD with respect to the potential at the first power terminal 1 is applied to the second control terminal 9, an ESD protection diode 70 turns on, to discharge the surge current from the second control terminal 9 to the first power terminal 1. When a negative ESD with respect to the potential at the first power terminal 1 is applied to the second control terminal 9, the first RC circuit 3 responds to the ESD, to drop the voltage in the first resistor 31. Accordingly, the potential of the first common node 30 rises, a signal of High level is supplied to the inverter 54, and a signal of Low level is supplied from the inverter 54 to the NAND circuit 56. As the negative ESD with respect to the potential at the first power terminal 1 is applied to the second control terminal 9, the potential of the second common node 130 attains a Low level, a signal of Low level is supplied to the inverter 55, and an output signal of High level is supplied from the inverter 55 to the NAND circuit 56. Therefore, as the NAND circuit 56 receives the signals of High level from the inverter 55 and Low level from the inverter 54, the output attains a High level. When the signal of High level is supplied to the gate electrode of the first shunt NMOS transistor 4, the first shunt NMOS transistor 4 turns on and further an ESD protection diode 80 turns on, to discharge the surge current from the first power terminal 1 to the second control terminal 9.

When a negative ESD with respect to the potential at the second power terminal 2 is applied to the second control terminal 9, the ESD protection diode 80 turns on, to discharge the surge current from the second power terminal 2 to the second control terminal 9. When a positive ESD with respect to the potential at the second power terminal 2 is applied to the second control terminal 9, the potential level of the second common node 130 attains a High and a signal of Low level is supplied from the inverter 55 to an input terminal of the NAND circuit 56. Therefore, a signal of High level is supplied from the NAND circuit 56 to the gate electrode of the first shunt NMOS transistor 4. Accordingly, the first NMOS transistor 4 turns on and further the ESD protection diode 70 turns on, to discharge the surge current from the second control terminal 9 to the second power terminal 2.

In a case where a semiconductor device in which the ESD protection circuit according to the embodiment installed is assembled on a predetermined board (not shown), when the predetermined power supply voltages, namely, a power supply voltage (Vdd) on a high potential level and a power supply voltage (ground potential Vss) on a low potential level, are applied to the first power terminal 1 and the second power terminal 2, a power supply voltage (ground potential Vss) on a low potential level is applied to the first control terminal 6 and the second control terminal 9, as a fixed potential. In this mode, the potential of the first control terminal 6 is at Low level and the inverter 54 inverts the potential, and supplies a signal of High level to an input terminal of the NAND circuit 56. The potential of the second control terminal 9 is also at Low level and the inverter 55 inverts the potential, and supplies the signal of High level to the NAND circuit 56. According to this, the two inputs of the NAND circuit 56 are at High level and a signal of Low level is output from the NAND circuit 56. Thus, the first shunt NMOS transistor 4 receives the signal of Low level in the gate electrode and the first shunt NMOS transistor 4 is turned off. Namely, the first shunt NMOS transistor 4 is forcibly turned off at the start-up of the power supply when the predetermined power supply voltages are applied to the first power terminal 1 and the second power terminal 2. This can avoid a malfunction of the first shunt NMOS transistor 4 at the start-up of the power supply. Accordingly, it is possible to avoid the generation of a rush current at the start-up of the power supply and the situation in which the power supply voltage fails to reach a predetermined voltage because of the rush current.

The embodiment has two sets of RC circuits 3 and 13 including the common node 30 for connecting the resistor 31 and the capacitor 32 connected to the first control terminal 6 and the common node 130 for connecting the resistor 131 and the capacitor 132 connected to the second control terminal 9 respectively. When at least one of the control terminals is in a floating state, the logic circuit can supply such a signal that turns on the shunt NMOS transistor 4 according to the output signal of the RC circuit, to the gate electrode of the shunt NMOS transistor 4. With respect to the ESD applied to the first control terminal 6 or the second control terminal 9, the ESD protection diode or the shunt NMOS transistor turns on, to discharge the surge current as the ESD protection element.

### Fourth Embodiment

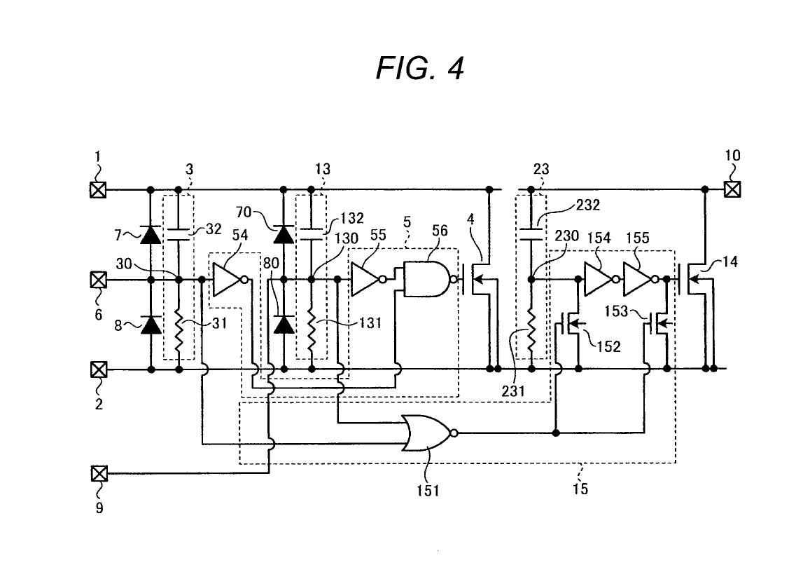

FIG. 4 is a circuit diagram showing an ESD protection circuit according to a fourth embodiment. The same reference numerals are attached to the components corresponding to the components of the ESD protection circuits according to the first through third embodiments shown in FIGS. 1 to 3 and descriptions thereof are omitted. When a semiconductor device has a plurality of circuit functions, circuit blocks are separated according to each function and each power is separately supplied to each block (hereinafter, referred to as separate power supply structure). In the separate power supply structure, the power is not supplied to the circuit block which does not need to operate, which can restrain the power consumption. This embodiment shows an exemplification suitable for the separate power supply structure. The embodiment has a third power terminal 10. A power supply voltage (Vdd) on a high potential level having the same voltage as that of the first power terminal 1, or a power supply voltage (Vdd1) on a high potential level having the different voltage from Vdd is applied to the third power terminal 10. A circuit block (not shown) operated by the power supply voltage applied between these power terminals is connected between the third power terminal 10 and the second power terminal 2. This circuit block operates under the separate system from another circuit block (not shown) operated by the power supply voltage applied between the first power terminal 1 and the second power terminal 2.

A third RC circuit 23 is connected between the third power terminal 10 and the second power terminal 2. The third RC circuit 23 includes a third capacitor 232 and a third resistor 231 which are connected in series between the third power terminal 10 and the second power terminal 2. The third capacitor 232 is connected to the third resistor 231 at a third common node 230.

The embodiment has a second logic circuit 15. The second logic circuit 15 includes two inverters 154 and 155 connected between the third common node 230 and the gate electrode of a second shunt NMOS transistor 14. The second logic circuit 15 includes a NOR circuit 151 with its input terminals being connected to the first common node 30 and the second common node 130. The second logic circuit 15 includes an NMOS transistor 152 with its drain electrode being connected to the third common node 230 and its source electrode being connected to the second power terminal 2. The second logic circuit 15 further includes an NMOS transistor 153 with its drain electrode being connected to the gate electrode of the second shunt NMOS transistor 14 and its source electrode being connected to the second power terminal 2. The output of the NOR circuit 151 is supplied to the gate electrodes of the NMOS transistors 152 and 153. In this embodiment, the second logic circuit 15 responds to the potentials of the first control terminal 6, the second control terminal 9, and the third common node 230; when the potentials of the first control terminal 6 and the second control terminal 9 are both at Low level, the second logic circuit 15 supplies a signal for turning off the second shunt NMOS transistor 14 to the gate electrode of the second shunt NMOS transistor 14.

This embodiment does not need to connect any diode, for the ESD protection, between the third common node 230 and the third power terminal 10 and between the second power terminal 2 and the third common node 230. This is because any external terminal to which ESD may be applied is not connected to the third RC circuit 23 and the third common node 230.

In the embodiment, when the predetermined power supply voltages, namely, a power supply voltage (Vdd) on a high potential level and a power supply voltage (ground potential Vss) on a low potential level are not applied to the first power terminal 1, the second power terminal 2, and the third power terminal 10, a control signal is not applied to the first control terminal 6 and the second control terminal 9. Therefore, the potentials of the first control terminal 6 and the second control terminal 9 are in the floating state. In this mode, when a positive ESD with respect to the potential of the second power terminal 2 is applied to the first power terminal 1, the first RC circuit 3 and the second RC circuit 13 respond to the ESD. Due to a voltage drop in the first resistor 31 of the first RC circuit 3 and a voltage drop in the second resistor 131 of the second RC circuit 13, the potentials of the first common node 30 and the second common node 130 rise, and when the input levels of the inverter 54 and the inverter 55 attains a High, the inverter 54 and the inverter 55 supply signals of Low level to the NAND circuit 56.

When receiving the signals of Low level from the inverter 54 and the inverter 55, the NAND circuit 56 supplies the output signal of High level to the gate electrode of the first shunt NMOS transistor 4. Accordingly, the first shunt NMOS transistor 4 turns on, to discharge the surge current from the first power terminal 1 to the second power terminal 2.

Similarly, when a positive ESD with respect to the potential of the second power terminal is applied to the third power terminal 10, the third RC circuit 23 responds to the ESD. Due to a voltage drop in the third resistor 131 of the third RC circuit 23, the potential of the third common node 130 rises. When the input level of the inverter 154 attains a High, the inverter 155 outputs the signal of High level to the gate electrode of the second shunt NMOS transistor 14. Accordingly, the second shunt NMOS transistor 14 turns on, to discharge the surge current from the third power terminal 10 to the second power terminal 2.

In a case where a semiconductor device in which the ESD protection circuit according to the embodiment installed is assembled on a predetermined board (not shown), when the predetermined power supply voltages, namely, a power supply voltage (Vdd) on a high potential level and a power supply voltage (ground potential Vss) on a low potential level are applied to the first power terminal 1 and the second power terminal 2, a power supply voltage (ground potential Vss) on a low potential level, which is a fixed potential, is applied to the first control terminal 6 and the second control terminal 9, as the control signals. In this mode, the potential of the first control terminal 6 is at Low level and the inverter 54 inverts the potential, to supply a signal of High level to the input terminal of the NAND circuit 56. The potential of the second control terminal 9 is also at Low level and the inverter 55 inverts the potential, to supply a signal of High level to the NAND circuit 56. Here, the NAND circuit 56 supplies a signal of Low level. Accordingly, the first shunt NMOS transistor 4 is turned off because of receiving the signal of Low level in the gate electrode. Accordingly, at the start-up of the power supply when the predetermined power supply voltages are applied to the first power terminal 1 and the second power terminal 2, the first shunt NMOS transistor 4 is forcibly turned off, which can avoid the generation of a rush current caused by a malfunction of the first shunt NMOS transistor 4 at the start-up of the power supply or the situation of failing in a power supply voltage being raised enough.

When a power supply voltage (ground potential Vss) on a low potential level, which is a fixed potential, is applied to the first control terminal 6 and the second control terminal 9, as a control signal, a signal of Low level is supplied to the both input terminals of the NOR circuit 151 of the second logic circuit 15, and the output of the NOR circuit 151 attains a High level. When a signal of High level is supplied to the gate electrodes of the NMOS transistors 152 and 153, the NMOS transistors 152 and 153 are turned on. Accordingly, as the potential of the gate electrode of the second shunt NMOS transistor 14 attains a Low level, the second shunt NMOS transistor 14 is turned off. Accordingly, at the start-up of the power supply when the predetermine power supply voltages are applied to the third power terminal 10 and the second power terminal 2, the second shunt NMOS transistor 14 is forcibly turned off, which can avoid the generation of rush current caused by a malfunction of the second shunt NMOS transistor 14 at the start-up of the power supply or the situation of failing in the power supply voltage being raised enough.

A control of the second shunt NMOS transistor 14 according to the power supply to the third power terminal 10, which is the separate power source, can be unified with a control of the first shunt NMOS transistor 4 according to the application of the control signal to the first control terminal 6 and the second control terminal 9, so the control of the first and second shunt NMOS transistors 4 and 14 can be unified.

Even when the number of the circuit blocks which are operated in the separate power supply structure increases, the number of the control terminals to which the control signals are supplied can be two. The output of the second logic circuit 15 is supplied to the gate electrode of the shunt NMOS transistor 14 with the main current channel being connected between the power terminals of the respective circuit blocks (not shown). As mentioned above, by applying a fixed potential to the two control terminals, the shunt NMOS transistor can be forcibly turned off.

As the prevention of the malfunction of the shunt transistor at the start-up of the power supply is the main purpose, the application of the control signal to the control terminal may be stopped at a normal time after the start-up of the power supply. Without the application of the control signal, the shunt transistor operates depending on the output signal supplied from the RC circuit. Although the embodiment using the NMOS transistor for the shunt transistor is described, a PMOS transistor may be used for the shunt transistor. In this case, the positions of the resistor and the capacitor are replaced with each other in each RC circuit. Alternatively, the number of the inverters in the logic circuit is increased or decreased by one. Further, a bipolar transistor may be used for the shunt transistor. In this case, with respect to a bias relationship, the NPN transistor corresponds to the shunt NMOS transistor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A protection circuit to protect another circuit from an electrostatic discharge, comprising:
a first transistor having a drain electrode, a source electrode, and a gate electrode;
a first terminal connected to the drain electrode;
a second terminal connected to the source electrode;
a first RC circuit including a capacitor and a resistor connected in series, the first RC circuit being connected between the first and the second terminals;
a logic circuit having an input terminal and an output terminal, the input terminal of the logic circuit connected between the capacitor and the resistor, and the output terminal of the logic circuit connected to the gate electrode of the first transistor; and
a third terminal connected between the capacitor and the resistor.

2. The protection circuit according to claim 1, further comprising:
a first diode having an anode electrode and a cathode electrode, the anode electrode of the first diode being connected to the third terminal and the cathode electrode of the first diode being connected to the first terminal.

3. The protection circuit according to claim 1, further comprising:
a second diode having an anode electrode and a cathode electrode, the anode electrode of the second diode being connected to the second terminal and the cathode electrode of the second diode being connected to the third terminal.

4. The protection circuit according to claim 1, wherein
the third terminal is supplied with a control signal to turn off the first transistor at a start time of when electric potentials to operate the circuit to be protected are supplied to the first and the second terminals.

5. The protection circuit according to claim 1, further comprising:
a second RC circuit including a capacitor and a resistor connected in series, the second RC circuit being connected between the first and the second terminals; and
a fourth terminal connected between the capacitor and the resistor of the second RC circuit, wherein
the logic circuit has two input terminals, and one of the input terminal is connected between the capacitor and the resistor of the second RC circuit.

6. The protection circuit according to claim 5, further comprising:
a third diode having an anode electrode and a cathode electrode, the anode electrode of the third diode being connected to the fourth terminal and the cathode electrode of the third diode being connected to the first terminal.

7. The protection circuit according to claim 5, further comprising:
a fourth diode having an anode electrode and a cathode electrode, the anode electrode of the fourth diode being connected to the second terminal and the cathode electrode of the fourth diode being connected to the fourth terminal.

8. The protection circuit according to claim 5, wherein
the third and the fourth terminals are supplied with a control signal to turnoff the first transistor at a start time of when electric potentials to operate the circuit to be protected are supplied to the first and the second terminals.

9. The protection circuit according to claim 5, wherein
the logic circuit is configured to output a control signal to turn off the first transistor if the electrostatic discharge is applied to one of the terminals when at least one of the third and the fourth terminals is in a floating state.

10. The protection circuit according to claim 5, further comprising:
a second transistor having a drain electrode, a source electrode connected to the second terminal, and a gate electrode;
a fifth terminal connected to the drain electrode of the second transistor;
a third RC circuit including a capacitor and a resistor connected in series, the third RC circuit being connected between the second and the fifth terminals; and
a second logic circuit having first, second, and third input terminals and an output terminal, the first input terminal being connected to the third terminal, the second input terminal being connected to the fourth terminal, and the third input terminal being connected between the capacitor and the resistor of the third RC circuit.

11. The protection circuit according to claim 10, wherein
the third and the fourth terminals are supplied with a control signal to turn off the second transistor at a start time of when electric potentials to operate the circuit to be protected are supplied to the second and the fifth terminals.

12. The protection circuit according to claim 10, wherein
the logic circuit is configured to output the control signal to turn off the first and the second transistors if the electrostatic discharge is applied to one of the terminals when at least one of the third and the fourth terminals is in a floating state.
